(19) United States
(12) Patent Application Publication
(10) Pub. No.: US 2017/0184291 A1
(43) Pub. Date: Jun. 29, 2017

(54) OPTICAL DEVICE

(71) Applicant: EVERREADY PRECISION IND. CORP., Kohsiung City (TW)

(72) Inventors: JYH-LONG CHERN, TAIPEI CITY (TW); CHIH-MING YEN, New Taipei City (TW)

(21) Appl. No.: 15/013,556

(22) Filed: Feb. 2, 2016

(30) Foreign Application Priority Data
Dec. 23, 2015 (CN) 201510980006.4
Dec. 23, 2015 (TW) 104143365

(51) Int. Cl. F21V 23/04; F21V 5/00; H04N 5/225; G02B 27/42

(52) U.S. Cl. CPC F21V 23/0442; G02B 27/425; F21V 5/008; H04N 5/2256; F21V 23/0414; F21Y 2115/00

(57) ABSTRACT

An optical device includes a structured light generation unit, a light-emitting unit, a sensing unit and a substrate. After the light beams from the light-emitting unit pass through the structured light generation unit, a structured light pattern is generated. When the structured light is projected on an object, a structured light pattern is formed on the object. The sensing unit provides a sensing function. Moreover, the light-emitting unit and the sensing unit are integrally formed on the substrate. The optical device can output the structured light to provide diversified function. Since the light-emitting unit and the sensing unit are integrated, the occupied space is reduced.

### FIELD OF THE INVENTION

The present invention relates to an optical device, and more particularly to an optical device for providing a structured light.

### BACKGROUND OF THE INVENTION

With the active progress of modern electronic industries and the advance of mass production technologies, various electronic products are designed and fabricated toward small size, light weightiness and easy portability. Subsequently, these electronic products can be applied to mobile business, entertainment or leisure purposes whenever or wherever the users are. Recently, people pay much attention to the integrations and applications of mechanical, optical and electrical technologies. Consequently, a variety of optical devices such as image capturing devices or lighting devices are gradually and extensively applied to various electronic products (e.g., smart phones, wearable devices or other portable electronic products). Accordingly, according to the practical requirements, users can take the electronic products and use them whenever the users want. In other words, these electronic products not only have important technical values but also provide more colorful lives to people.

With the improvement of the living quality, people's demands on more functions of the electronic products are progressively increased. Consequently, the demands on the optical devices of the electronic products are steadily increased. For meeting these demands, some literatures about the generation of structured lights have been disclosed. For example, in a pending Taiwanese Patent Application No. 104115679, the applicant of the present invention discloses an optical device for outputting a structured light to detect a test surface and obtain the distance and the flatness of the test surface. Moreover, in a pending Taiwanese Patent Application No. 104115677, the applicant of the present invention discloses an output device for outputting two structured lights to a test object in order to obtain accurate depth information.

In the current technology of generating the structured light, a sensing unit is required to sense the structured light pattern. Conventionally, the light-emitting unit and the sensing unit of the optical device are individual and separate components. Under this circumstance, generally the optical device or the electronic product with the optical device cannot achieve the purpose of small size and light weightiness. Therefore, it is important to develop the structured light technology to provide diversified functions to the electronic product without increasing the volume of the electronic product.

### SUMMARY OF THE INVENTION

For solving the drawbacks of the conventional technologies, the present invention provides an optical device for outputting a structured light to provide diversified functions. A light-emitting unit and a sensing unit of the optical device are integrated. Consequently, the occupied space is reduced.

In accordance with an aspect of the present invention, there is provided an optical device. The optical device includes a structured light generation unit, a light-emitting unit, a sensing unit and a substrate. The light-emitting unit includes at least one light source. After a light beam outputted from the at least one light source passes through the structured light generation unit, a structured light is generated. When the structured light is projected on an object, a structured light pattern is formed on the object. The sensing unit provides a sensing function. The light-emitting unit and the sensing unit are integrally formed on the substrate.

In an embodiment, the sensing function includes a thermal sensing function, an electric sensing function, a magnetic sensing function, an optical sensing function and/or a function of sensing the structured light pattern.

In an embodiment, the sensing unit comprises a complementary metal-oxide semiconductor, an ambient light sensor, a photodiode, a proximity sensor or a thermal sensor.

In an embodiment, the optical device further includes a control unit. The control unit is electrically connected between the light-emitting unit and the sensing unit. The control unit controls the light-emitting unit according to a sensing result of the sensing unit.

In an embodiment, the at least one light source comprises plural light sources. Under control of the control unit or processing unit, each of the plural light sources outputs the light beam or stops outputting the light beam according to a predetermined sequence.

In an embodiment, the at least one light source includes at least one lighting chip or at least one lighting die.

In an embodiment, the at least one light source includes a laser diode, a light emitting diode, an organic light emitting diode and/or a thermal source.

In an embodiment, the at least one light source includes plural light sources, and the plural light sources are arranged around the sensing unit.

In an embodiment, the light beam has a wavelength in a first wavelength range, a second wavelength range and/or a thermal band.

In an embodiment, the structured light generation unit includes a diffractive optical element, a lenticular lens group and/or a micro-lens array.

In an embodiment, the optical device further includes a collimating lens group. The collimating lens group is arranged between the light-emitting unit and the structured light generation unit. After the light beam from the light-emitting unit is collimated by the collimating lens group, the collimated light beam is transmitted to the structured light generation unit.

In an embodiment, the light-emitting unit outputs the light beam or stops outputting the light beam according to a predetermined sequence.

In an embodiment, the sensing unit provides the sensing functions or stops providing the sensing function according to a predetermined sequence.

In an embodiment, the optical device further includes a casing. The structured light generation unit, the light-emitting unit and the sensing unit are accommodated and fixed within the casing.

In an embodiment, the substrate is a stepped structure, or the substrate is a stack structure of multiple substrate layers, or one of the plural substrate layers of the substrate is a ground layer.

In an embodiment, the optical device is included in a portable electronic product.

From the above descriptions, the sensing unit and the light-emitting unit of the present invention are integrated. That is, the sensing unit and the light-emitting unit are not separate components. Consequently, the overall space occupied by the sensing unit and the light-emitting unit is reduced. Under this circumstance, the optical device or the electronic product with the optical device can be designed toward small size, light weightiness and easy portability.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the operating concept of an optical device according to a first embodiment of the present invention;

FIG. 2 schematically illustrates a substrate, a light-emitting unit and a sensing unit of the optical device of FIG. 1 and taken along another viewpoint;

FIG. 3 schematically illustrates the operating concept of an optical device according to a second embodiment of the present invention;

FIG. 4 schematically illustrates a substrate, a light-emitting unit and a sensing unit of an optical device according to a third embodiment of the present invention;

FIG. 5 schematically illustrates a substrate, a light-emitting unit and a sensing unit of an optical device according to a fourth embodiment of the present invention; and

FIG. 6 schematically illustrates a portable electronic product using the optical device of the present invention.

### DETAILED DESCRIPTION OF THE PREFERRED EMBODIMENT

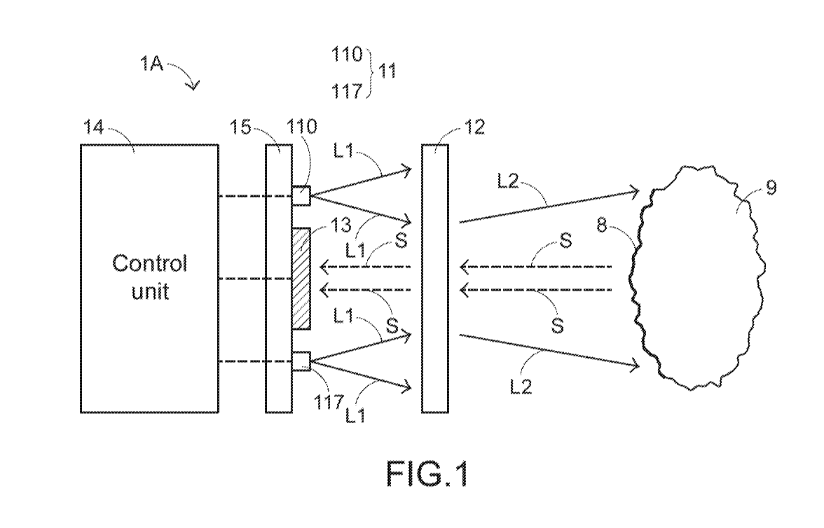

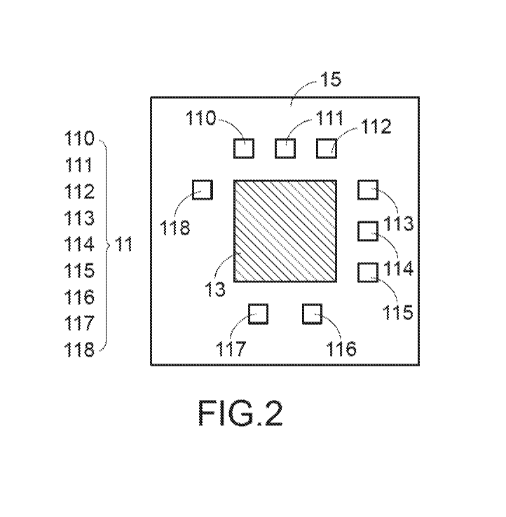

FIG. 1 schematically illustrates the operating concept of an optical device according to a first embodiment of the present invention. FIG. 2 schematically illustrates a substrate, a light-emitting unit and a sensing unit of the optical device of FIG. 1 and taken along another viewpoint. As shown in FIGS. 1 and 2, the optical device 1A comprises a light-emitting unit 11, a structured light generation unit 12, a sensing unit 13, a control unit 14 and a substrate 15. The control unit 14 is electrically connected between the light-emitting unit 11 and the sensing unit 13. Moreover, the sensing 13 and the light-emitting unit 11 are integrally formed on the same substrate 15.

In this embodiment, the light-emitting unit 11 comprises plural light sources 110˜118. An example of each of the light sources 110˜118 includes but is not limited to a laser diode (LD), a light emitting diode (LED), an organic light emitting diode (OLED), a thermal source or any other comparable semiconductor-type light-emitting element similar to the laser diode, the light emitting diode or the organic light emitting diode. The wavelengths of the light beams L1 outputted from the light-emitting unit 11 are in a first wavelength range and/or a second wavelength range. For example, the light beams L1 from each of the light sources 110˜118 are visible beams, invisible beams (e.g., ultraviolet beams, infrared beams, near infrared beams or far infrared beams), or light beams in a thermal band. Each of the light sources 110˜118 is lighting chip or a light die. In addition, the light sources 110˜118 are arranged around the sensing unit 13. It is noted that the number of the light sources 110˜118, the types of the light sources 110˜118 and the relative positions between the light sources 110˜118 and the sensing unit 13 are not restricted.

When the light beams L1 pass through the structured light generation unit 12, the light beams L1 are shaped by the structured light generation unit 12. Consequently, a structured light L2 is outputted. When the structured light L2 is projected on an object 9, a structured light pattern 8 is formed on the object 9. Moreover, the structured light generation unit 12 can be designed according to the practical requirements. Consequently, the outputted structured light L2 and the structured light pattern 8 on the object 9 can be flexibly adjusted.

Preferably but not exclusively, the structured light generation unit 12 comprises a diffractive optical element (DOE), a lenticular lens group and/or a micro-lens array. The ways of designing the structured light generation unit 12 to generate the structured light L2 according to the user's requirements are well known to those skilled in the art, and are not redundantly described herein.

According to the practical situations, the sensing unit 13 provides the required sensing function. For example, the sensing unit 13 is used for sensing the change of the structured light pattern 8 on the object 9. Alternatively, the sensing function of the sensing unit 13 includes a thermal sensing function, an electric sensing function, a magnetic sensing function or an optical sensing function of sensing the surroundings of the optical device 1A. That is, the sensing unit 13 is used for sensing an ambient signal S from the surroundings of the optical device 1A. For example, the ambient signal is a thermal signal, an electric signal, a magnetic signal or an optical signal. Preferably but not exclusively, the sensing unit 13 comprises a complementary metal-oxide semiconductor (CMOS), an ambient light sensor (ALS), a photodiode, a proximity sensor and/or a thermal sensor.

The control unit 14 controls the light-emitting unit 11 according to a sensing result of the sensing unit 13. Under control of the control unit 14, each of the light sources 110˜118 outputs the light beams L1 or stops outputting the light beams L 1 according to a predetermined sequence. That is, under control of the control unit 14, each of the light sources 110˜118 outputs the light beams L1 at a specified time interval and stops outputting the light beams L1 at another specified time interval. Moreover, under control of the control unit 14, the sensing unit 13 provides the sensing function or stops providing the sensing function according to a predetermined sequence.

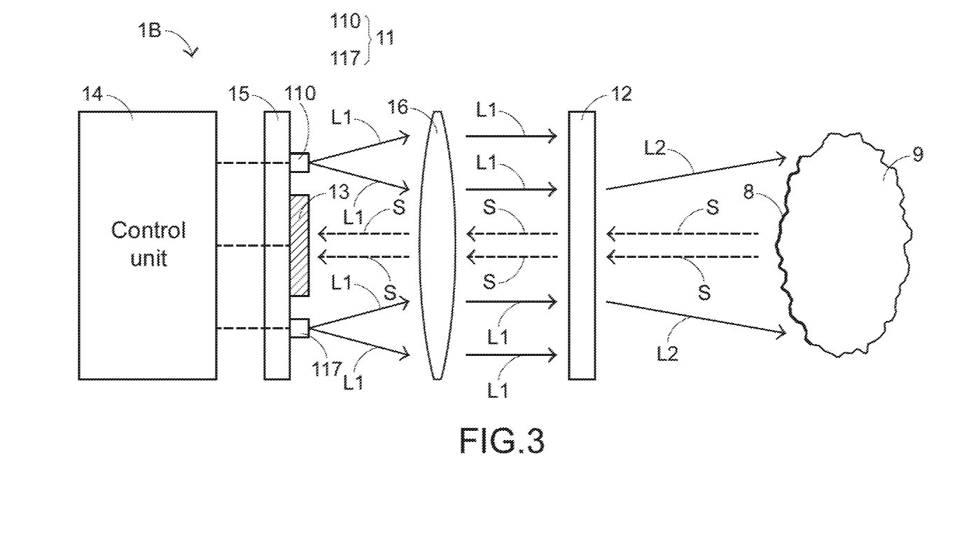

FIG. 3 schematically illustrates the operating concept of an optical device according to a second embodiment of the present invention. The structure and function of the optical device 1B that are similar to those of the first embodiment are not redundantly described herein. In comparison with the first embodiment, the optical device 1B of this embodiment further comprises a collimating lens group 16. The collimating lens group 16 is arranged between the light-emitting unit 11 and the structured light generation unit 12. After the light beams L1 from the light-emitting unit 11 are collimated by the collimating lens group 16, the collimated light beams are transmitted to the structured light generation unit 12. As known, if the light beams are not collimated, portion of the light beams are not utilized by the structured light generation unit 12. In this embodiment, the light beams L1 from the light-emitting unit 11 are collimated by the collimating lens group 16, and thus the plural light beams L1 are in parallel with each other and directed to the structured light generation unit 12. Consequently, the light utilization efficiency of the optical device 1B is enhanced.

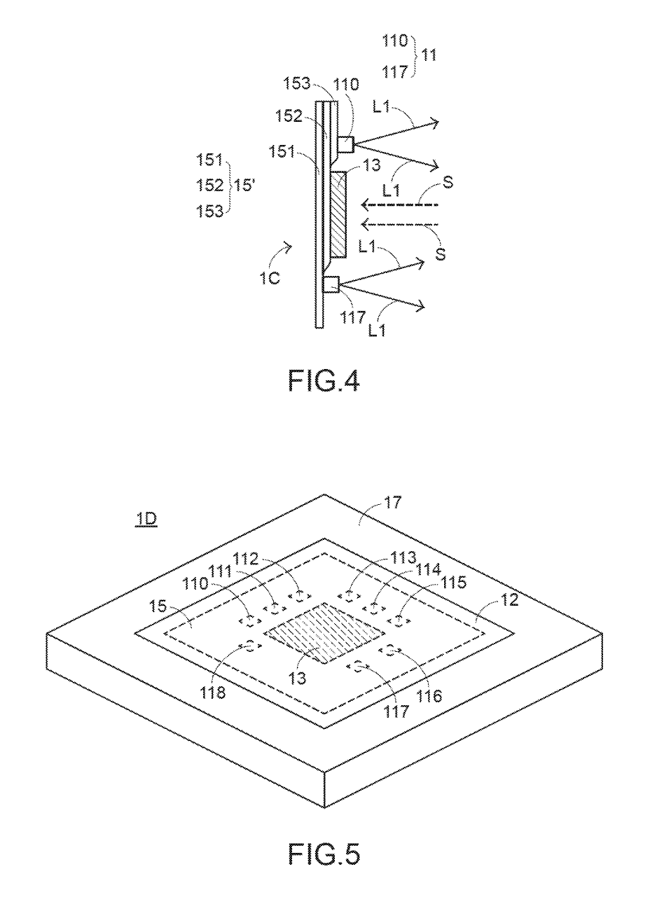

FIG. 4 schematically illustrates a substrate, a light-emitting unit and a sensing unit of an optical device according to a third embodiment of the present invention. The structure and function of the optical device 1C that are similar to those of the first embodiment and the second embodiment are not redundantly described herein. In comparison with the first embodiment and the second embodiment, the substrate 15′ of the optical device 1C is a stepped structure. For example, the substrate 15′ is a stack structure of multiple substrate layers 151˜153. In addition, the substrate layer 151 of the substrate 15′ is a ground layer.

FIG. 5 schematically illustrates a substrate, a light-emitting unit and a sensing unit of an optical device according to a fourth embodiment of the present invention. The structure and function of the optical device 1D that are similar to those of the first embodiment, the second embodiment and the third embodiment are not redundantly described herein. In comparison with the first embodiment, the second embodiment and the third embodiment, the optical device 1D of this embodiment further comprises a casing 17. The structured light generation unit 12, the light-emitting unit 11, the sensing unit 13 and the control unit 14 are accommodated and fixed within the casing 17.

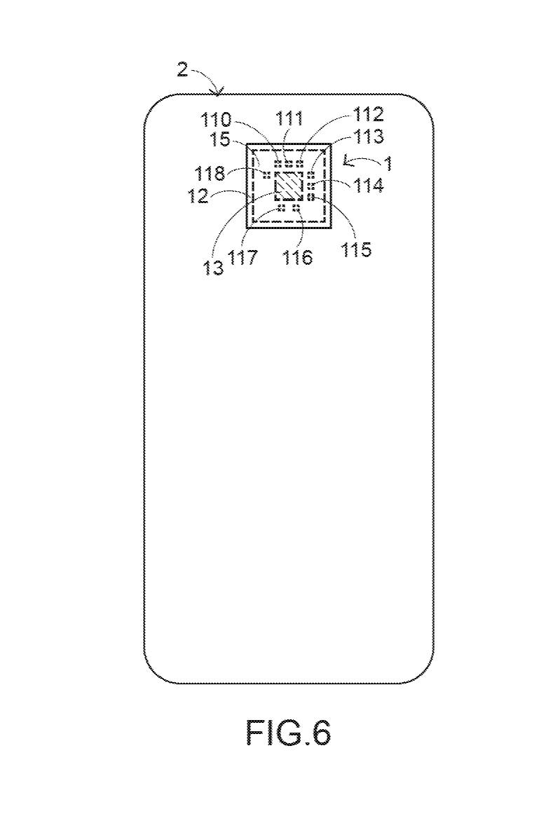

FIG. 6 schematically illustrates a portable electronic product using the optical device of the present invention. The portable electronic product 2 as shown in FIG. 6 is equipped with the optical device 1 of the first embodiment or the second embodiment. An example of the portable electronic product 2 includes but is not limited to a mobile phone, a tablet computer or a wearable device. It is noted that the optical device 1 of the present invention may be applied to other electronic products while retaining the teachings of the invention.

From the above descriptions, the sensing unit and the light-emitting unit of the present invention are integrated. That is, the sensing unit and the light-emitting unit are not separate components. Consequently, the overall space occupied by the sensing unit and the light-emitting unit is reduced. Under this circumstance, the optical device or the electronic product with the optical device can be designed toward small size, light weightiness and easy portability. Moreover, the structured light generated by the optical device can provide diversified functions.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An optical device, comprising:
a structured light generation unit;
a light-emitting unit comprising at least one light source, wherein after a light beam outputted from the at least one light source passes through the structured light generation unit, a structured light is generated, wherein when the structured light is projected on an object, a structured light pattern is formed on the object;
a sensing unit providing a sensing function; and
a substrate, wherein the light-emitting unit and the sensing unit are integrally formed on the substrate.

2. The optical device according to claim 1, wherein the sensing function includes a thermal sensing function, an electric sensing function, a magnetic sensing function, an optical sensing function and/or a function of sensing the structured light pattern.

3. The optical device according to claim 1, wherein the sensing unit comprises a complementary metal-oxide semiconductor, an ambient light sensor, a photodiode, a proximity sensor or a thermal sensor.

4. The optical device according to claim 1, further comprising a control unit, wherein the control unit is electrically connected between the light-emitting unit and the sensing unit, and the control unit controls the light-emitting unit according to a sensing result of the sensing unit.

5. The optical device according to claim 4, wherein the at least one light source comprises plural light sources, wherein under control of the control unit, each of the plural light sources outputs the light beam or stops outputting the light beam according to a predetermined sequence.

6. The optical device according to claim 1, wherein the at least one light source includes at least one lighting chip or at least one lighting die.

7. The optical device according to claim 1, wherein the at least one light source includes a laser diode, a light emitting diode, an organic light emitting diode and/or a thermal source.

8. The optical device according to claim 1, wherein the at least one light source comprises plural light sources, and the plural light sources are arranged around the sensing unit.

9. The optical device according to claim 1, wherein the light beam has a wavelength in a first wavelength range, a second wavelength range and/or a thermal band.

10. The optical device according to claim 1, wherein the structured light generation unit comprises a diffractive optical element, a lenticular lens group and/or a micro-lens array.

11. The optical device according to claim 1, further comprising a collimating lens group, wherein the collimating lens group is arranged between the light-emitting unit and the structured light generation unit, wherein after the light beam from the light-emitting unit is collimated by the collimating lens group, the collimated light beam is transmitted to the structured light generation unit.

12. The optical device according to claim 1, wherein the light-emitting unit outputs the light beam or stops outputting the light beam according to a predetermined sequence.

13. The optical device according to claim 1, wherein the sensing unit provides the sensing functions or stops providing the sensing function according to a predetermined sequence.

14. The optical device according to claim 1, further comprising a casing, wherein the structured light generation unit, the light-emitting unit and the sensing unit are accommodated and fixed within the casing.

15. The optical device according to claim 1, wherein the substrate is a stepped structure, or the substrate is a stack structure of multiple substrate layers, or one of the plural substrate layers of the substrate is a ground layer.

16. The optical device according to claim 1, wherein the optical device is included in a portable electronic product.
